(19) United States
(12) Patent Application Publication
(10) Pub. No.: US 2016/0357379 A1
(43) Pub. Date: Dec. 8, 2016

(54) SCHEDULE MANAGEMENT SYSTEM AND SCHEDULE MANAGEMENT METHOD

(71) Applicant: Azbil Corporation, Chiyoda-ku (JP)

(72) Inventor: Toru KASHIMA, Chiyoda-ku (JP)

(73) Assignee: Azbil Corporation, Chiyoda-ku (JP)

(21) Appl. No.: 15/167,371

(22) Filed: May 27, 2016

(30) Foreign Application Priority Data
Jun. 5, 2015 (JP) 2015-114653

(51) Int. Cl. G06F 3/0484; G05B 15/02

(52) U.S. Cl. CPC G06F 3/0484; G05B 15/02

(57) ABSTRACT

A schedule management system that includes processing circuitry that generates schedule information for managing operation of equipment, generates changed schedule information by changing the schedule information in response to a request for changing the schedule information, generates equipment operation time information representing an operation time of the equipment when the equipment operates in accordance with the schedule information or the changed schedule information, creates a presentation screen including information on a first difference between the schedule information and the changed schedule information and a second difference between the changed schedule information and the equipment operation time information, and controls a display to display the presentation screen.

### CROSS-REFERENCE TO RELATED APPLICATIONS

This application claims priority to Japanese Application No. 2015-114653, filed Jun. 5, 2015, the entire contents of which are incorporated herein by reference.

### FIELD

The present disclosure relates to a schedule management system and a schedule management method, and particularly to a schedule management system and a schedule management method for managing schedules of a plurality of pieces of equipment installed in a building.

### BACKGROUND

A large facility such as a building is equipped with a building monitoring system that monitors and controls, in a centralized manner, operation statuses of various pieces of installed equipment (hereinafter simply referred to as “pieces of equipment”) located in the building, such as heat-source equipment, air-conditioning equipment, and lighting equipment, by displaying the operation statuses on monitoring screens in a monitoring room.

In this kind of building monitoring system, it is necessary to set in advance a schedule in a control apparatus that controls and manages operation of equipment in order to operate the equipment in accordance with the schedule for the purpose of energy saving.

As the control apparatus, there has been suggested a system that displays, side by side, time information representing a scheduled start time and end time when equipment is operated in accordance with a schedule (hereinafter referred to as “schedule information”) and time information representing an actual equipment operation start time and equipment operation end time when the equipment is actually operated (hereinafter referred to as “equipment operation time information”), so that a user recognizes a gap between a scheduled operation time and an actual operation time when the equipment is operated in accordance with the scheduled start time and end time (see, for example, Japanese Unexamined Patent Application Publication No. 2012-243258).

For example, as illustrated in FIG. 21, a schedule management system 10 that manages an operation schedule of equipment includes lighting equipment 11, a control apparatus 12 that individually controls the operation of the lighting equipment 11, a central control apparatus 13 that generates schedule information for operating the lighting equipment 11 and sets the schedule information to the control apparatus 12, and an on-site operation device 14 that changes the schedule information set to the control apparatus 12 at a site where the lighting equipment 11 is installed.

The control apparatus 12 stores, in a storage unit provided therein, the schedule information received from the central control apparatus 13 and controls the operation of the lighting equipment 11 in accordance with the schedule information. For example, as illustrated in FIG. 22, if the schedule information is time information indicating that the lighting equipment 11 is to be turned on at a start time 8:00 and turned off at an end time 18:00, the control apparatus 12 controls the operation of the lighting equipment 11 in accordance with the schedule information.

Here, it is assumed that an operator on the site where the lighting equipment 11 is installed performs an operation of changing the end time in the schedule information given to the control apparatus 12 from 18:00 to 19:00 by using the on-site operation device 14 in order to extend the operation period of the lighting equipment 11 one hour.

In this case, the control apparatus 12 generates and stores changed schedule information by changing the end time in the schedule information from 18:00 to 19:00, and thereafter performs control in accordance with the changed schedule information so as to turn off the lighting equipment 11 at the end time 19:00.

Accordingly, the lighting equipment 11 is turned off in response to a control signal indicating a turn-off command supplied from the control apparatus 12 at the end time 19:00 indicated by the changed schedule information.

On the other hand, as illustrated in FIG. 23, if a request for changing the schedule information is not made by the operator using the on-site operation device 14 after the control apparatus 12 turns on the lighting equipment 11 at the start time 8:00, the control apparatus 12 controls the operation as scheduled so as to turn off the lighting equipment 11 at the end time 18:00.

However, if some failure occurs in communication between the control apparatus 12 and the lighting equipment 11 and if the lighting equipment 11 is not able to receive a control signal indicating a turn-off command from the control apparatus 12 and thereafter receives the control signal at 19:00, the lighting equipment 11 is turned off at 19:00, which is one hour later than the end time 18:00 indicated by the schedule information.

However, the control apparatus 12 according to the related art merely displays schedule information and equipment operation time information side by side, as illustrated in FIGS. 24A to 25B. When both are compared to each other, the end time 19:00 of the lighting equipment 11 is the same both in a case where a turn-off operation of the lighting equipment 11 is delayed one hour in accordance with changed schedule information (hereinafter referred to as a “delay in operation”) and in a case where a one-hour delay in operation occurs in the lighting equipment 11 due to communication failure.

In this case, the operator is not able to specify which is the cause of a delay in operation of the lighting equipment 11, change of schedule information or communication failure.

### SUMMARY

According to one aspect of the disclosure, there is provided a schedule management system, comprising: processing circuitry configured to generate schedule information for managing operation of equipment; generate changed schedule information by changing the schedule information in response to a request for changing the schedule information; generate equipment operation time information representing an operation time of the equipment when the equipment operates in accordance with the schedule information or the changed schedule information; create a presentation screen including information on a first difference between the schedule information and the changed schedule information and a second difference between the changed schedule information and the equipment operation time information; and control a display to display the presentation screen.

### BRIEF DESCRIPTION OF THE DRAWINGS

FIG. 1 is a block diagram illustrating the configuration of a schedule management system according to a first embodiment;

FIG. 2 is a block diagram illustrating the configuration of a control apparatus;

FIG. 3 is a diagram for describing schedule information;

FIG. 4 is a diagram for describing changed schedule information;

FIG. 5 is a diagram for describing equipment operation time information;

FIG. 6 is a block diagram illustrating the configuration of a central control apparatus;

FIG. 7 is a diagram illustrating a comparison screen in a case where changed schedule information different from schedule information is obtained;

FIG. 8 is a diagram illustrating a comparison screen in a case where equipment operation time information different from changed schedule information is obtained;

FIG. 9 is a flowchart illustrating a procedure of a process of creating and displaying a comparison screen;

FIG. 10 is a block diagram illustrating the configuration of a central control apparatus according to a second embodiment;

FIG. 11 is a diagram for describing differences among schedule information, changed schedule information, and equipment operation time information;

FIG. 12 is a block diagram illustrating the configuration of a difference-visualized-screen creating unit;

FIG. 13 is a diagram illustrating a histogram screen for a plurality of pieces of lighting equipment;

FIG. 14 is a diagram illustrating a warning screen;

FIG. 15 is a diagram illustrating a transition screen;

FIG. 16 is a flowchart illustrating a procedure of a process of creating and displaying a difference visualized screen;

FIG. 17 is a diagram for describing generation of numerical information according to a third embodiment;

FIG. 18 is a diagram illustrating a chronological histogram screen for one piece of lighting equipment according to the third embodiment;

FIG. 19 is a diagram illustrating a comparison screen in a case where a plurality of pieces of changed schedule information are generated according to a fourth embodiment;

FIG. 20 is a diagram illustrating a histogram screen in a case where a plurality of pieces of changed schedule information are generated according to the fourth embodiment;

FIG. 21 is a block diagram illustrating the configuration of a schedule management system according to the related art;

FIG. 22 is a diagram illustrating equipment operation time information in a case where equipment operates in accordance with changed schedule information generated by changing schedule information;

FIG. 23 is a diagram illustrating equipment operation time information in a case where equipment does not operate in accordance with schedule information and changed schedule information;

FIGS. 24A and 24B are diagrams illustrating operation of equipment in a case where schedule information is changed; and

FIGS. 25A and 25B are diagrams illustrating operation of equipment in a case where schedule information is not changed.

### DETAILED DESCRIPTION

The present disclosure is directed to providing a schedule management system and a schedule management method that enable easy specification of a cause of a delay in operation of equipment when an unscheduled operation is performed by the equipment.

A schedule management system (100) according to an embodiment of the present disclosure includes a schedule information generating unit (51) that generates schedule information (S1) for managing operation of equipment (11a); a changed schedule information generating unit (20c) that generates changed schedule information (CS1) by changing the schedule information (S1) in response to a remote request for changing the schedule information (S1); an equipment operation time information generating unit (20e) that generates equipment operation time information (D1) representing an operation time when the equipment (11a) operates in accordance with the schedule information (S1) or the changed schedule information (CS1); a screen creating unit (52, 54) that creates a presentation screen (G1 to G4) that enables recognition of a first difference (df1) between the schedule information (S1) and the changed schedule information (CS1) and a second difference (df2) between the changed schedule information (CS1) and the equipment operation time information (D1); and a display control unit (56) that displays the presentation screen (G1 to G4) on a display unit (60).

The screen creating unit (52, 54) includes a comparison screen creating unit (52) that generates a predetermined schedule information screen (SG1), a predetermined changed schedule information screen (CSG1), and a predetermined equipment operation time information screen (DG1) on the basis of the schedule information (S1), the changed schedule information (CS1), and the equipment operation time information (D1), and that creates, as the presentation screen (G1 to G4), a comparison screen (G1) on which the schedule information screen (SG1), the changed schedule information screen (CSG1), and the equipment operation time information screen (DG1) are arranged so as to enable comparison among the screens.

The screen creating unit (52, 54) includes a numerical calculation unit (53) that calculates first numerical information (v1) and second numerical information (v2), the first numerical information (v1) being obtained by converting the first difference (df1) into a numerical format, the second numerical information (v2) being obtained by converting the second difference (df2) into a numerical format.

The screen creating unit (52, 54) further includes a graph screen creating unit (54a) that creates a graph screen (G2) as the presentation screen (G1 to G4) on the basis of the first numerical information (v1) and the second numerical information (v2), the graph screen (G2) enabling the first difference (df1) and the second difference (df2) to be visualized.

The screen creating unit (52, 54) further includes a warning screen creating unit (54b) that creates a warning screen (G3) as the presentation screen (G1 to G4) on the basis of the first numerical information (v1) and the second numerical information (v2), the warning screen (G3) representing a warning indicating that there are the first difference (df1) and the second difference (df2).

The screen creating unit (52, 54) further includes a transition screen creating unit (54c) that creates a transition screen (G4) as the presentation screen (G1 to G4) on the basis of the second numerical information (v2), the transition screen (G4) representing chronological transition of the second difference (df2).

The numerical calculation unit (53) calculates the first numerical information (v1) in an operating time section in which the equipment (11a) is operating and the first numerical information (v1′) in a non-operating time section in which the equipment (11a) is not operating, and the graph screen creating unit (54a) creates the graph screen (G2S) on the basis of the first numerical information (v1) in the operating time section and the first numerical information (v1′) in the non-operating time section.

The changed schedule information generating unit (20c) generates a plurality of pieces of changed schedule information (CS1, CS2) in response to a plurality of requests for changing the schedule information (S1), and the comparison screen creating unit (52) creates a plurality of changed schedule information screens (CSG1, CSG2) on the basis of the plurality of pieces of changed schedule information (CS1, CS2) and creates a comparison screen (G1S) on which the schedule information screen (SG1), the plurality of changed schedule information screens (CSG1, CSG2), and the equipment operation time information screen (DG1) are arranged so as to enable comparison among the screens.

According to an embodiment of the present disclosure, the presentation screen (G1 to G4) that enables recognition of the first difference (df1) between the schedule information (S1) and the changed schedule information (CS1) and the second difference (df2) between the changed schedule information (CS1) and the equipment operation time information (D1) is displayed. Accordingly, an operator is able to recognize the first difference (df1) and the second difference (df2) and is thus able to specify, on the basis of the first difference (df1) and the second difference (df2), a cause of operation that is performed by the equipment (11a) and that is different from an operation indicated by the schedule information (S1).

Hereinafter, first to fourth embodiments of the present disclosure will be described with reference to the attached drawings.

### First Embodiment

A schedule management system according to the first embodiment is a system that enables, if a delay occurs in operation of lighting equipment whose operation is managed in accordance with schedule information, an operator to specify the cause of the delay by visualizing and displaying a time difference between the schedule information and changed schedule information and a time difference between the changed schedule information and equipment operation time information representing an operation time of the lighting equipment.

### Configuration of Schedule Management System

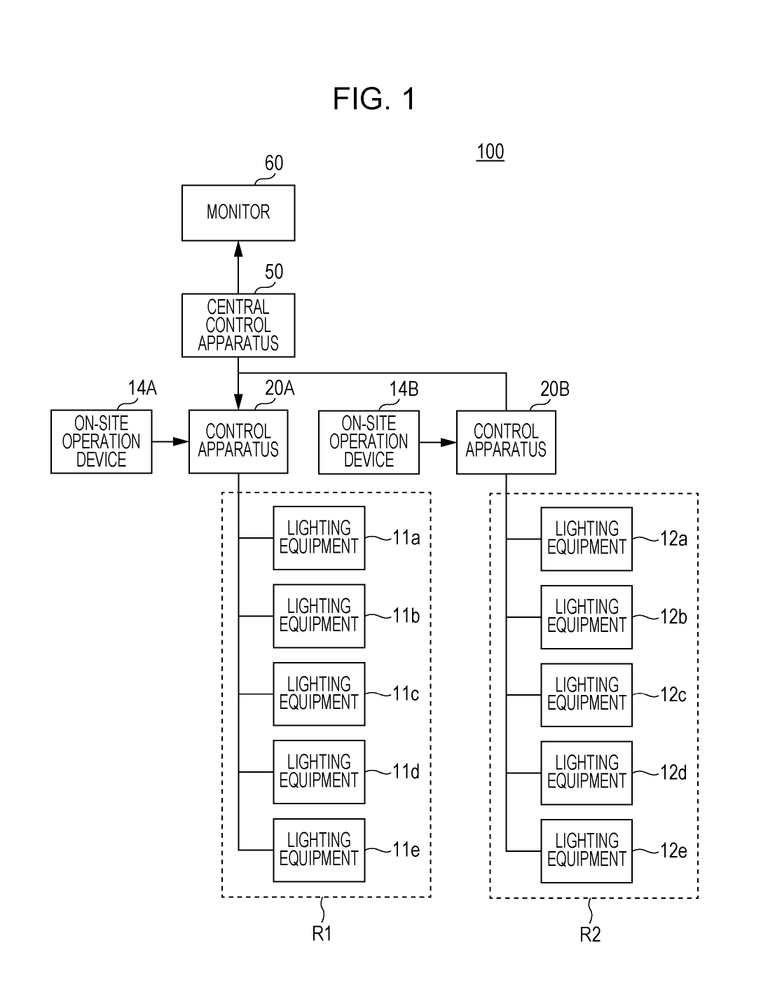

As illustrated in FIG. 1, a schedule management system 100 according to the first embodiment of the present disclosure includes a plurality of pieces of lighting equipment 11a to 11e and 12a to 12e, control apparatuses 20A and 20B that control the operation of these pieces of lighting equipment, a central control apparatus 50 that controls the control apparatuses 20A and 20B, a monitor 60, and on-site operation devices 14A and 14B that are used to change the operation of lighting equipment at the site where the lighting equipment is installed.

### Lighting Equipment

The pieces of lighting equipment 11a to 11e and 12a to 12e are fluorescent lights, light emitting diodes (LEDs), or the like installed on the ceilings of rooms R1 and R2 in a building. All the pieces of lighting equipment 11a to 11e and 12a to 12e have the same configuration.

### Control Apparatus

The control apparatuses 20A and 20B are functional units that control the operation of the pieces of lighting equipment 11a to 11e and 12a to 12e, respectively. The control apparatuses 20A and 20B are implemented by installing a computer program (software) into a computer (hardware) including a central processing unit (CPU), a memory, an interface, and so forth, and individual functional units (described below) of the control apparatuses 20A and 20B are implemented by cooperation between various hardware resources of the computer and the computer program. The control apparatuses 20A and 20B have the same configuration, and thus a description will be given of the configuration of the control apparatus 20A for convenience.

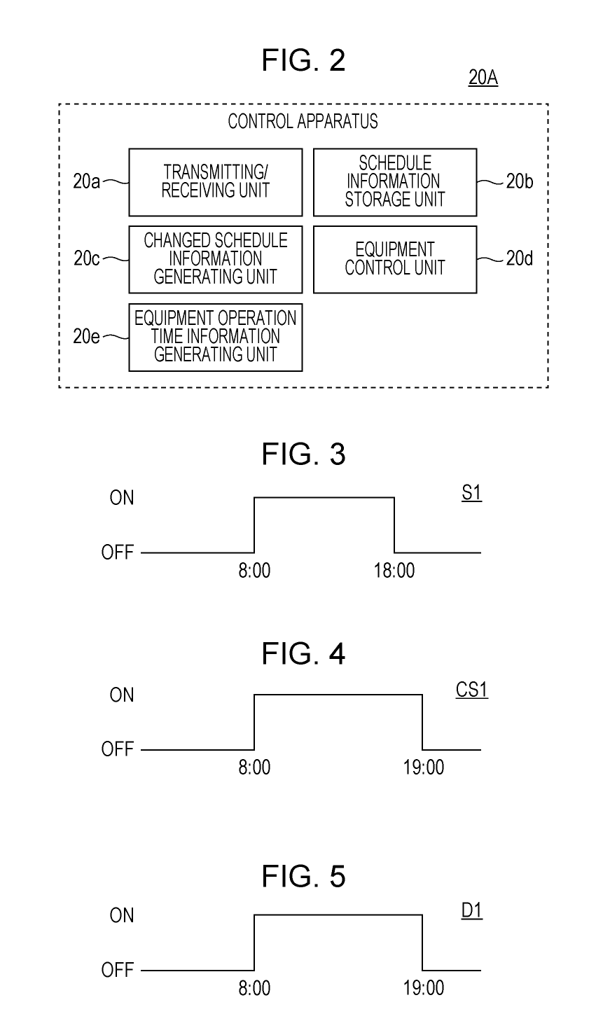

As illustrated in FIG. 2, the control apparatus 20A includes a transmitting/receiving unit 20a, a schedule information storage unit 20b, a changed schedule information generating unit 20c, an equipment control unit 20d, and an equipment operation time information generating unit 20e.

### Transmitting/Receiving Unit

The transmitting/receiving unit 20a is a functional unit that performs data transmission/reception between the central control apparatus 50 and the pieces of lighting equipment 11a to 11e.

Specifically, the transmitting/receiving unit 20a has a function of receiving schedule information from the central control apparatus 50 and transmitting control signals for controlling the operation of the pieces of lighting equipment 11a to 11e to the pieces of lighting equipment 11a to 11e.

### Schedule Information Storage Unit

The schedule information storage unit 20b is a storage unit constructed on a memory and stores schedule information received from the central control unit 50 via the transmitting/receiving unit 20a.

As illustrated in FIG. 3, schedule information S1 is time information for chronologically managing the operation of the lighting equipment 11a in accordance with a start time 8:00 represented by “ON” and an end time 18:00 represented by “OFF”.

### Changed Schedule Information Generating Unit

The changed schedule information generating unit 20c is a functional unit that changes the start time or end time in the schedule information S1 in response to receipt of a remote request for changing the schedule information S1 from the on-site operation device 14A and that generates schedule information that has been changed (hereinafter referred to as “changed schedule information”).

As illustrated in FIG. 4, changed schedule information CS1 is time information for chronologically managing the operation of the lighting equipment 11a in accordance with a start time 8:00 represented by “ON” and an end time 19:00 represented by “OFF”, like the schedule information S1. In the changed schedule information CS1, the end time 18:00 in the schedule information S1 is changed to 19:00.

After generating the changed schedule information CS1, the changed schedule information generating unit 20c stores the changed schedule information CS1 in the schedule information storage unit 20b. The changed schedule information CS1 is transmitted to a comparison screen creating unit 52 by the transmitting/receiving unit 20a in addition to being stored in the schedule information storage unit 20b.

If a change request is not received from the on-site operation device 14A, the changed schedule information generating unit 20c does not change the schedule information S1 and stores the schedule information S1 as the changed schedule information CS1 in the schedule information storage unit 20b.

### Equipment Control Unit

The equipment control unit 20d is a functional unit that generates a control signal indicating a turn-on command or turn-off command in accordance with the start time and end time in the schedule information S1 or the changed schedule information CS1 and that outputs the control signal to the pieces of lighting equipment 11a to 11e by using the transmitting/receiving unit 20a.

### Equipment Operation Time Information Generating Unit

The equipment operation time information generating unit 20e is a functional unit that generates, in accordance with a control signal output from the transmitting/receiving unit 20a, time information representing an equipment operation start time and an equipment operation end time when the lighting equipment 11a is actually turned on and turned off (hereinafter referred to as “equipment operation time information”). After generating the equipment operation time information about the lighting equipment 11a, the equipment operation time information generating unit 20e transmits it to the comparison screen creating unit 52 by using the transmitting/receiving unit 20a.

As illustrated in FIG. 5, equipment operation time information D1 is time information that chronologically represents a start time 8:00 represented by “ON” and an end time 19:00 represented by “OFF” when the lighting equipment 11a actually operates in accordance with the changed schedule information CS1.

### On-Site Operation Device

The on-site operation devices 14A and 14B have the same configuration. Here, a description will be given of only the on-site operation device 14A for convenience. The on-site operation device 14A is a device operated by an operator when the operator wants to change the schedule information S1 with which the control apparatus 20A manages the operation of the lighting equipment 11a, and corresponds to, for example, a remote control located in the room R1 where the lighting equipment 11a is installed.

The on-site operation device 14A includes an input unit, a storage unit, and an arithmetic processing unit, although not illustrated. When an input operation of changing the end time 18:00 in the schedule information S1 to 19:00 is performed by the operator via the input unit, the on-site operation device 14A generates, by using the arithmetic processing unit, end time information representing the end time 19:00 as a request for changing the schedule information S1, and transmits the request to the control apparatus 20A.

### Central Control Apparatus

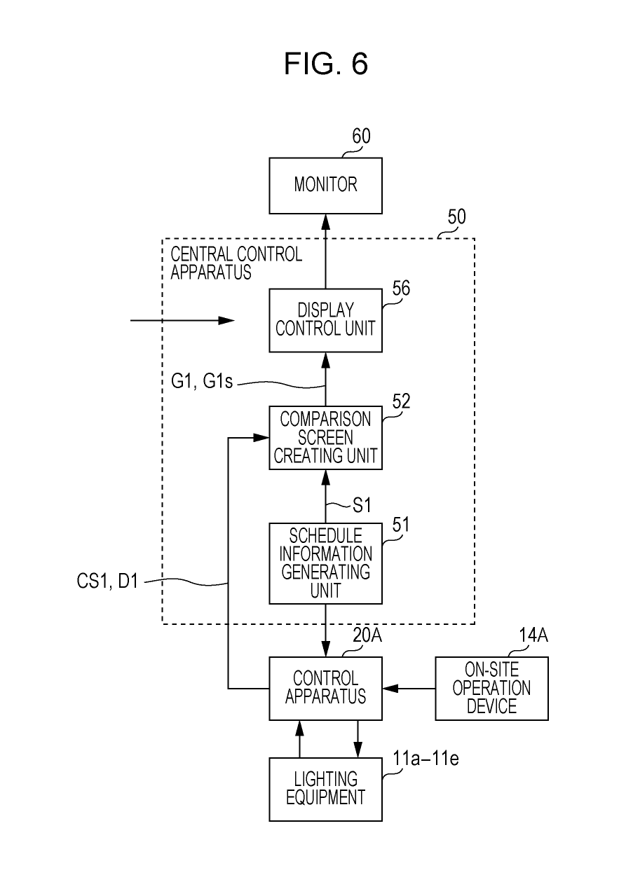

As illustrated in FIG. 6, the central control apparatus 50 manages the operation of the pieces of lighting equipment 11a to 11e and 12a to 12e by controlling the control apparatuses 20A and 20B in a centralized manner.

The central control apparatus 50 is implemented by installing a computer program (software) into a computer (hardware) including a CPU, a memory, and an interface such as a keyboard, and individual functional units (described below) of the central control apparatus 50 are implemented by cooperation between various hardware resources of the computer and the computer program. The central control apparatus 50 includes a schedule information generating unit 51, the comparison screen creating unit 52, and a display control unit 56.

### Schedule Information Generating Unit

The schedule information generating unit 51 is a functional unit that generates the schedule information S1 for managing the operation of the pieces of lighting equipment 11a to 11e. The schedule information generating unit 51 generates the schedule information S1 on the basis of time information representing a start time and an end time input by an operator. The schedule information S1 is output to the control apparatus 20A and the comparison screen creating unit 52.

### Comparison Screen Creating Unit

The comparison screen creating unit 52 is a functional unit that creates a presentation screen that enables a time difference between the schedule information S1 and the changed schedule information CS1 and a time difference between the changed schedule information CS1 and the equipment operation time information D1 to be visualized by an operator.

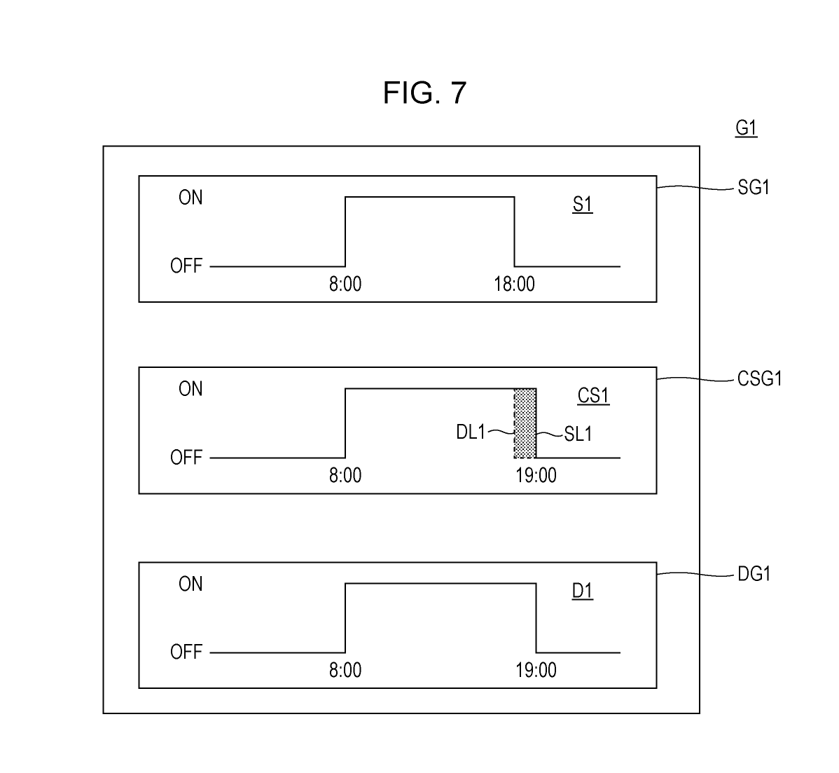

The comparison screen creating unit 52 creates a comparison screen G1 illustrated in FIG. 7 on the basis of the schedule information S1 received from the schedule information generating unit 51, the changed schedule information CS1 received from the control apparatus 20A, and the equipment operation time information D1. On the comparison screen G1, the schedule information S1, the changed schedule information CS1, and the equipment operation time information D1 are arranged such that they can be compared to one another.

Specifically, the comparison screen creating unit 52 creates a screen SG1 that enables a rise from OFF to ON at a start time 8:00 and a fall from ON to OFF at an end time 18:00 to be visualized, on the basis of the schedule information S1 (this screen is hereinafter referred to as a “schedule information screen”).

Likewise, the comparison screen creating unit 52 creates a screen CSG1 that enables a rise from OFF to ON at a start time 8:00 and a fall from ON to OFF at an end time 19:00 to be visualized, on the basis of the changed schedule information CS1 (this screen is hereinafter referred to as a “changed schedule information screen”).

Likewise, the comparison screen creating unit 52 creates a screen DG1 that enables a rise from OFF to ON at a start time 8:00 and a fall from ON to OFF at an end time 19:00 to be visualized, on the basis of the equipment operation time information D1 (this screen is hereinafter referred to as an “equipment operation time information screen”).

After that, the comparison screen creating unit 52 creates the screen G1 on which the schedule information screen SG1, the changed schedule information screen CSG1, and the equipment operation time information screen DG1 are vertically arranged in a line along the same time axis (this screen is hereinafter referred to as a “comparison screen”) and stores it in the storage unit.

In this way, the comparison screen creating unit 52 creates comparison screens G1 for the individual pieces of lighting equipment 11a to 11e on the basis of the schedule information S1, the changed schedule information CS1, and the equipment operation time information D1 and stores them in the storage unit.

The changed schedule information screen CSG1 displays not only a solid line SL1 representing the fall from ON to OFF at the end time 19:00 but also a broken line DL1 representing the fall from ON to OFF at the end time 18:00 in the schedule information S1 that has not been changed.

The space between the end time 18:00 and the end time 19:00 represented by the solid line SL1 and the broken line DL1 is colored in blue, for example. Here, the blue indicates that there is a gap of 60 minutes between the end time 18:00 in the schedule information S1 and the end time 19:00 in the changed schedule information CS1.

In this way, the comparison screen G1 visually indicates that there is a time difference between the schedule information S1 and the changed schedule information CS1 by using the solid line SL1 and the broken line DL1 on the changed schedule information screen CSG1.

Also, the comparison screen G1 visually indicates that there is a time difference between the end time 18:00 in the schedule information S1 and the end time 19:00 in the equipment operation time information D1 and that there is not a time difference between the end time 19:00 in the changed schedule information CS1 and the end time 19:00 in the equipment operation time information D1.

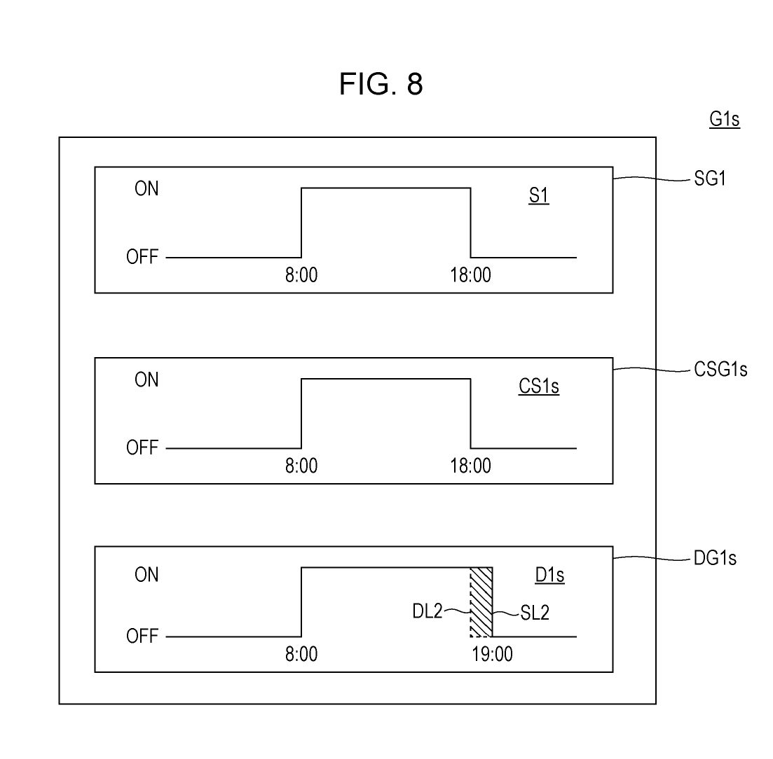

Furthermore, the comparison screen creating unit 52 creates a comparison screen G1s illustrated in FIG. 8 on which the schedule information S1, changed schedule information CS1s, and equipment operation time information D1s are arranged such that they can be compared to one another, in response to receipt of the schedule information S1 from the schedule information generating unit 51, the changed schedule information CS1s from the control apparatus 20A, and the equipment operation time information D1s.

That is, the comparison screen creating unit 52 creates the screen G1s on which the schedule information screen SG1, a changed schedule information screen CSG1s, and an equipment operation time information screen DG1s are vertically arranged in a line along the same time axis, similarly to the comparison screen G1.

The comparison screen G1s visually indicates that there is a time difference between the changed schedule information CS1s and the equipment operation time information D1s by using a solid line SL2 and a broken line DL2 on the equipment operation time information screen DG1s.

The space between the end time 18:00 and the end time 19:00 represented by the solid line SL2 and the broken line DL2 is colored in red, for example. Here, the red indicates that there is a gap of 60 minutes between the end time 18:00 in the schedule information S1 and the end time 19:00 in the equipment operation time information D1s.

In this way, the comparison screen G1s visually indicates that there is a time difference between the changed schedule information CS1s and the equipment operation time information D1s by using the solid line SL2 and the broken line DL2 in the equipment operation time information D1s.

Also, the comparison screen G1s visually indicates that there is not a time difference between the end time 18:00 in the schedule information S1 and the end time 18:00 in the changed schedule information CS1s and that there is a time difference between the end time 18:00 in the schedule information S1 and the end time 19:00 in the equipment operation time information D1s.

### Display Control Unit

The display control unit 56 is a functional unit that displays comparison screens G1 or comparison screens G1s for the individual pieces of lighting equipment 11a to 11e created by the comparison screen creating unit 52 on the monitor 60. The display control unit 56 is able to simultaneously display a plurality of comparison screens G1 corresponding to the individual pieces of lighting equipment 11a to 11e on the monitor 60.

### Operation of Central Control Apparatus

Now, a description will be given of the operation of the central control apparatus 50 of the schedule management system 100 having the above-described configuration. The central control apparatus 50 generates, by using the schedule information generating unit 51, schedule information S1 about the pieces of lighting equipment 11a to 11e, transmits the schedule information S1 to the control apparatus 20A, and causes the schedule information storage unit 20b of the control apparatus 20A to store the schedule information S1.

The control apparatus 20A outputs a control signal indicating a turn-on command at a start time 8:00 and outputs a control signal indicating a turn-off command at an end time 18:00 in accordance with the schedule information S1, and thereby controls the operation of the pieces of lighting equipment 11a to 11e.

At this time, in response to receipt of a request for changing the schedule information S1 from the on-site operation device 14A, the control apparatus 20A generates changed schedule information CS1 in accordance with the request and thereafter controls the operation of the pieces of lighting equipment 11a to 11e in accordance with the changed schedule information CS1.

After controlling the operation of the pieces of lighting equipment 11a to 11e in accordance with the changed schedule information CS1, the control apparatus 20A generates pieces of equipment operation time information D1 about the individual pieces of lighting equipment 11a to 11e and transmits them to the comparison screen creating unit 52 of the central control apparatus 50.

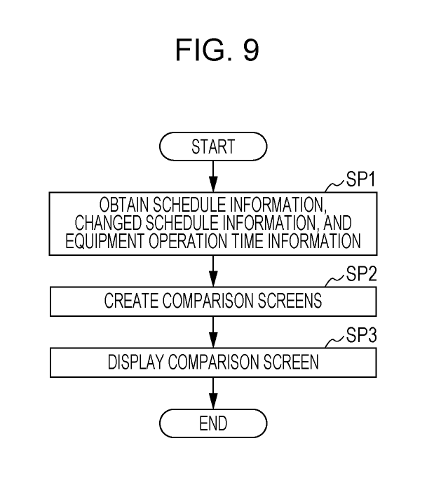

Referring to FIG. 9, the central control apparatus 50 obtains, by using the comparison screen creating unit 52, the schedule information S1 from the schedule information generating unit 51, the changed schedule information CS1 from the control apparatus 20A, and the pieces of equipment operation time information D1 about the pieces of lighting equipment 11a to 11e (step SP1).

Upon obtainment of the schedule information S1, the changed schedule information CS1, and the pieces of equipment operation time information D1, the central control apparatus 50 creates, by using the comparison screen creating unit 52, comparison screens G1 or G1s for the individual pieces of lighting equipment 11a to 11e (step SP2).

In response to receipt of, by the display control unit 56 of the central control apparatus 50, a remote request for displaying the comparison screen for the lighting equipment 11a, the display control unit 56 reads the comparison screen G1 or G1s for the lighting equipment 11a from the comparison screen creating unit 52, outputs it to the monitor 60, and displays it on the monitor 60 (step SP3). After that the process ends.

### Advantages of First Embodiment

The central control apparatus 50 outputs the comparison screen G1 (see FIG. 7) corresponding to the lighting equipment 11a in response to a display request from an operator. Accordingly, the monitor 60 is able to display the comparison screen G1 on which the schedule information screen SG1, the changed schedule information screen CSG1, and the equipment operation time information screen DG1 are vertically arranged in a line along the same time axis.

The operator compares the schedule information screen SG1, the changed schedule information screen CSG1, and the equipment operation time information screen DG1 that are vertically arranged in a line, and is thereby able to visually and intuitively recognize that there is a time difference between the schedule information S1 and the changed schedule information CS1 and that there is not a time difference between the changed schedule information CS1 and the equipment operation time information D1.

Specifically, the operator is able to determine that the space between the end time 18:00 and the end time 19:00 indicated by the broken line DL1 and the solid line SL1 displayed on the changed schedule information screen CSG1 is colored in blue and that there is not a time difference between the changed schedule information CS1 and the equipment operation time information D1.

Accordingly, the operator is able to instantaneously understand that the cause of the delay in operation when the lighting equipment 11a is turned off at the end time 19:00 that is one hour later than the end time 18:00 indicated by the schedule information S1 is the change of the end time indicated by the changed schedule information CS1.

If the central control apparatus 50 displays the comparison screen G1s (see FIG. 8) for the lighting equipment 11a on the monitor 60 in response to a display request from the operator, the central control apparatus 50 is able to allow the operator to visually check the comparison screen G1s.

The operator compares the schedule information screen SG1, the changed schedule information screen CSG1s, and the equipment operation time information screen DG1s that are vertically arranged in a line, and is thereby able to visually and intuitively recognize that there is not a time difference between the schedule information S1 and the changed schedule information CS1s and that there is a time difference between the changed schedule information CS1s and the equipment operation time information D1s.

Specifically, the operator is able to determine that the space between the end time 18:00 and the end time 19:00 indicated by the broken line DL2 and the solid line SL2 displayed on the equipment operation time information screen DG1s is colored in red and that there is not a time difference between the schedule information S1 and the changed schedule information CS1s.

Accordingly, the operator is able to instantaneously understand that the cause of the delay in operation when the lighting equipment 11a is turned off at the end time 19:00 that is one hour later than the end time 18:00 indicated by the changed schedule information CS1s is more likely to be failure in communication between the control apparatus 20A and the lighting equipment 11a.

### Second Embodiment

A schedule management system according to the second embodiment is a system that displays a list of the pieces of lighting equipment 11a to 11e that operate behind schedule represented by the schedule information S1 on the basis of a time difference between the schedule information S1 and the changed schedule information CS1 and a time difference between the changed schedule information CS1 and the equipment operation time information D1.

### Configuration of Schedule Management System

The schedule management system according to the second embodiment has the same configuration as that of the schedule management system 100 according to the first embodiment (see FIG. 1) except that the central control apparatus 50 is replaced with a central control apparatus 50S.

### Central Control Apparatus

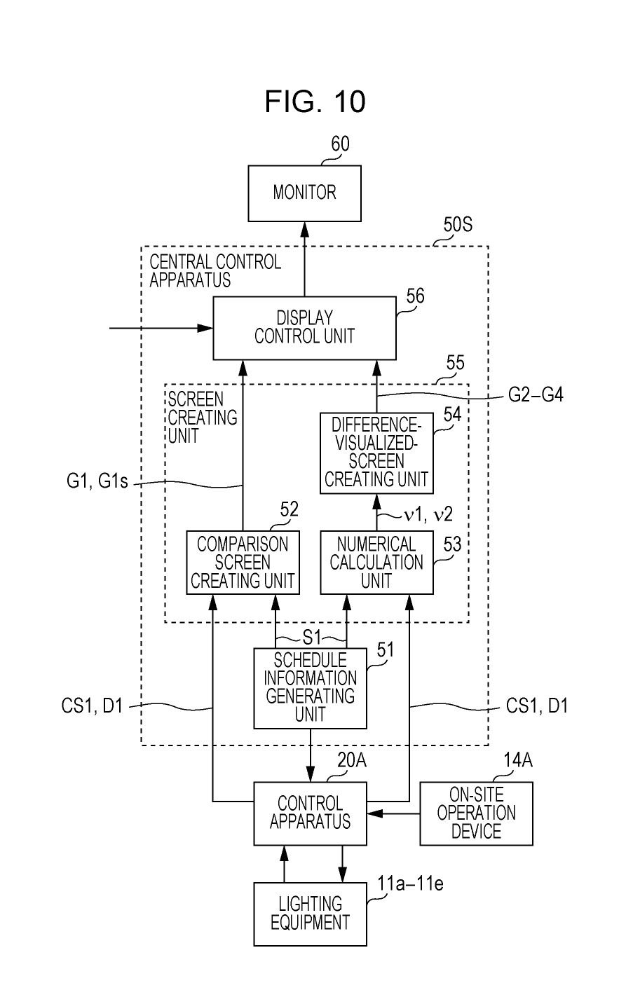

As illustrated in FIG. 10, the central control apparatus 50S according to the second embodiment includes the schedule information generating unit 51, a screen creating unit 55, and the display control unit 56. The central control apparatus 50S according to the second embodiment includes, in the screen creating unit 55, a numerical calculation unit 53 and a difference-visualized-screen creating unit 54 in addition to the comparison screen creating unit 52 according to the first embodiment. The schedule information generating unit 51 and the display control unit 56 are the same as those according to the first embodiment and denoted by the same reference numerals. The detailed description thereof is omitted.

### Screen Creating Unit

The screen creating unit 55 is a functional unit that creates a comparison screen G1 or a difference visualized screen (described below) that enables an operator to visually and intuitively recognize a time difference between the schedule information S1 and the changed schedule information CS1 and a time difference between the changed schedule information CS1 and the equipment operation time information D1 about the pieces of lighting equipment 11a to 11e.

The screen creating unit 55 includes the comparison screen creating unit 52, the numerical calculation unit 53, and the difference-visualized-screen creating unit 54.

### Numerical Calculation Unit

The numerical calculation unit 53 is a functional unit that converts a time difference between the schedule information S1 and the changed schedule information CS1 and a time difference between the changed schedule information CS1 and the equipment operation time information D1 into a numerical format.

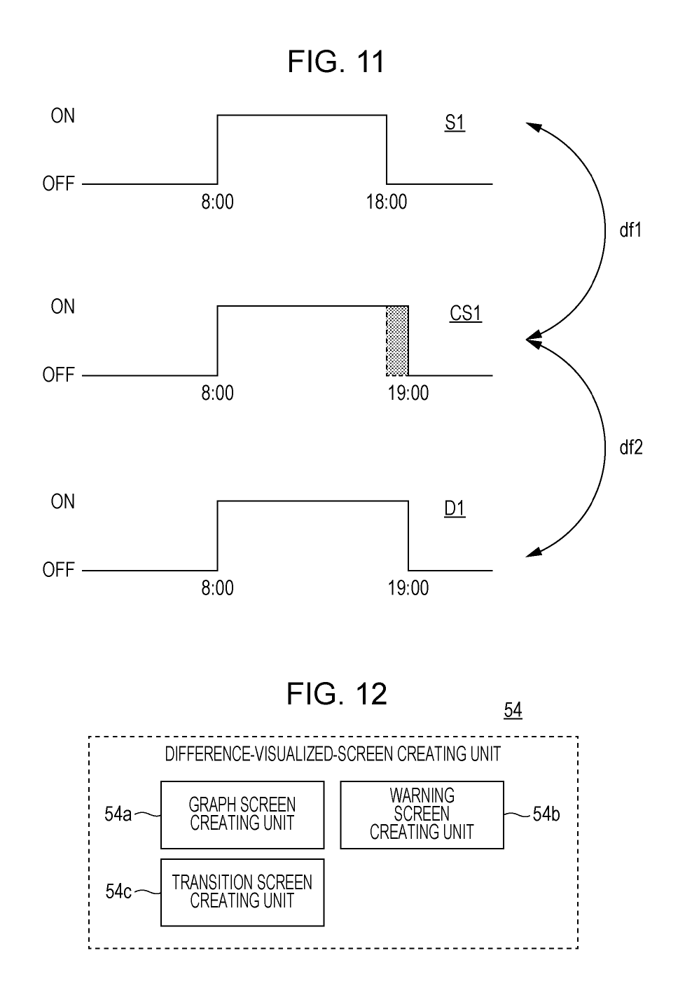

Specifically, as illustrated in FIG. 11, the numerical calculation unit 53 converts a time difference df1 between the schedule information S1 and the changed schedule information CS1 (hereinafter referred to as a “first difference”) into a numerical format to generate first numerical information v1 and converts a time difference df2 between the changed schedule information CS1 and the equipment operation time information D1 (hereinafter referred to as a “second difference”) into a numerical format to generate second numerical information v2.

The numerical calculation unit 53 calculates, by using the following Equation 1, first numerical information v1 which is a total sum of differences x(t) calculated at an interval of one minute by regarding “ON” in the schedule information S1 as “1” and regarding “OFF” in the changed schedule information CS1 as “0”.

v1=Σₜ|x(ₜ)| Equation 1

Here, t represents time, and Equation 1 means adding of absolute values of differences x(t) in one day from 0:00 to 23:59:59. In this case, the end time in the schedule information S1 is 18:00 whereas the end time in the changed schedule information CS1 is 19:00, and thus differences x(t) are obtained only for 60 minutes and the first numerical information v1 is “60”.

Also, the numerical calculation unit 53 is able to calculate second numerical information v2, which is obtained by converting the second difference df2 between the changed schedule information CS1 and the equipment operation time information D1 into a numerical format, by replacing “v1” in Equation 1 with “v2”.

In this case, the end time in the changed schedule information CS1 is 19:00 whereas the end time in the equipment operation time information D1 is 19:00, and thus there is no difference x(t) and the second numerical information v2 is “0”.

The numerical calculation unit 53 calculates first numerical information v1 and second numerical information v2 for each of the pieces of lighting equipment 11a to 11e and outputs the pieces of information to the difference-visualized-screen creating unit 54.

### Difference-Visualized-Screen Creating Unit

The difference-visualized-screen creating unit 54 is a functional unit that creates a screen that enables the first difference df1 between the schedule information S1 and the changed schedule information CS1 and the second difference df2 between the changed schedule information CS1 and the equipment operation time information D1 to be visualized (hereinafter this screen is referred to as a “difference visualized screen”), on the basis of the first numerical information v1 and the second numerical information v2.

As illustrated in FIG. 12, the difference-visualized-screen creating unit 54 includes a graph screen creating unit 54a, a warning screen creating unit 54b, and a transition screen creating unit 54c.

The graph screen creating unit 54a is a functional unit that creates histogram screens for the pieces of lighting equipment 11a to 11e on the basis of the first numerical information v1 and the second numerical information v2 calculated for each of the pieces of lighting equipment 11a to 11e by the numerical calculation unit 53, if operations different from those indicated by the schedule information S1 or the changed schedule information CS1 are performed by the pieces of lighting equipment 11a to 11e.

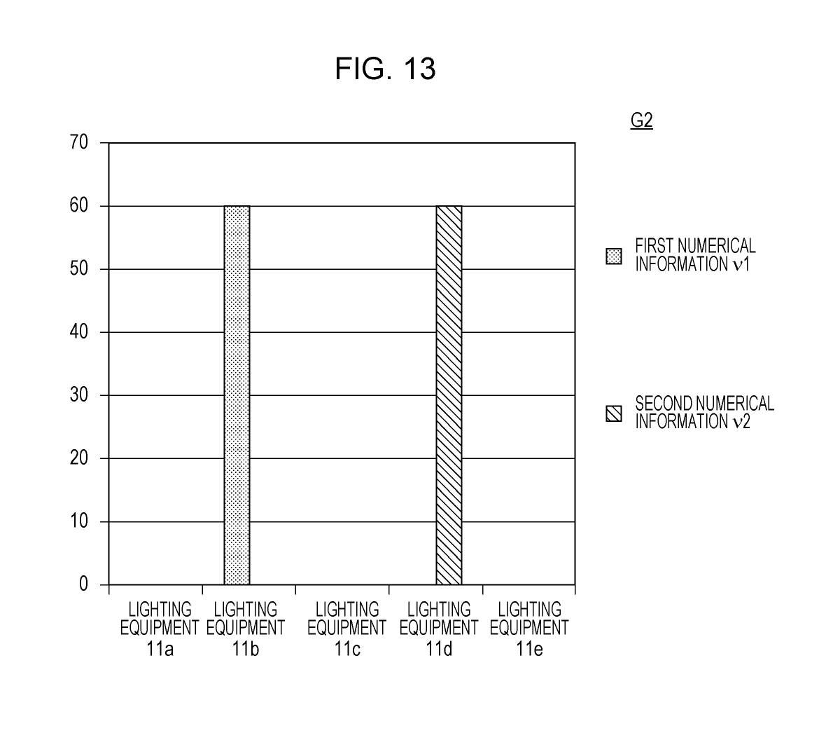

Specifically, if the first numerical information v1 for the lighting equipment 11b is “60” and if the second numerical information v2 for the lighting equipment 11d is “60”, for example, the graph screen creating unit 54a creates a histogram screen G2 illustrated in FIG. 13 in which the first numerical information v1 and the second numerical information v2 are reflected as bins for the pieces of lighting equipment 11b and 11d.

In the histogram screen G2, the bin for the lighting equipment 11b is colored in blue, which represents the difference df1, and the bin for the lighting equipment 11d is colored in red (hatched portion in FIG. 13), which represents the difference df2.

The warning screen creating unit 54b is a functional unit that creates a screen specifying only the lighting equipment for which a warning is to be given (hereinafter this screen is referred to as a “warning screen”), on the basis of the first numerical information v1 and the second numerical information v2 calculated for each of the pieces of lighting equipment 11a to 11e by the numerical calculation unit 53.

The warning screen creating unit 54b stores a threshold th1 (for example, “30”) that is to be compared with the first numerical information v1 and the second numerical information v2 calculated for each of the pieces of lighting equipment 11a to 11e.

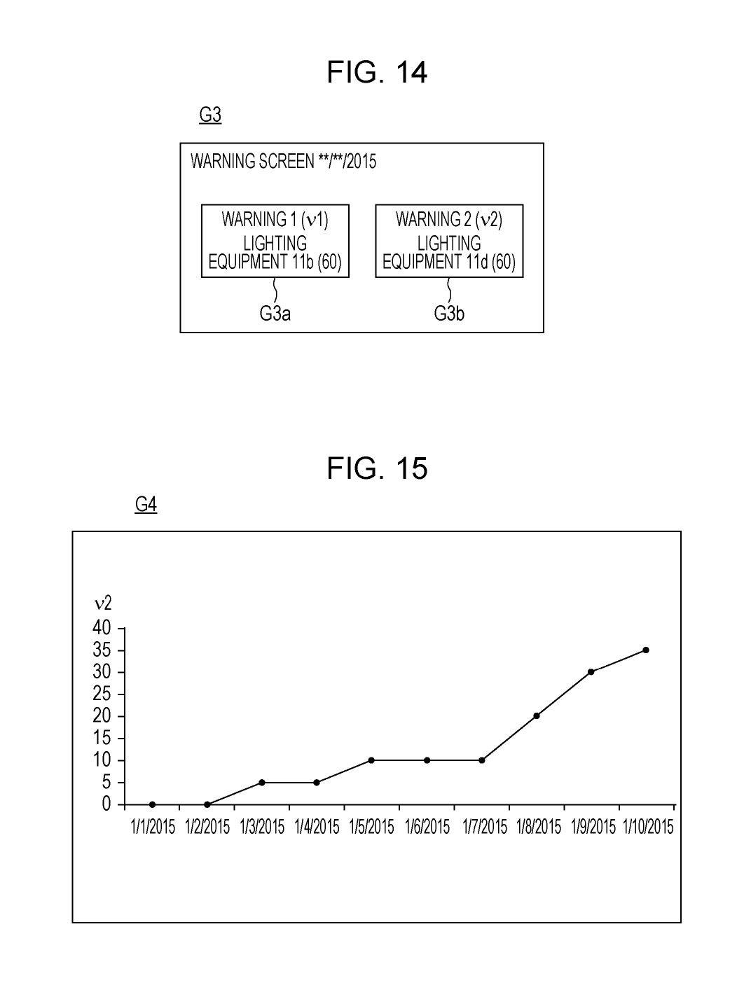

Specifically, it is assumed that the first numerical information v1 for the lighting equipment 11b is “60” and that the second numerical information v2 for the lighting equipment 11d is “60”. Since both the first numerical information v1 and the second numerical information v2 are larger than the threshold th1, the warning screen creating unit 54b creates a warning screen G3 illustrated in FIG. 14 that specifies the pieces of lighting equipment 11b and 11d for which a warning is to be given.

The warning screen G3 displays the date on which the warning is given (**/**/2015) and warning target display fields G3a and G3b indicating that the targets of warning are the pieces of lighting equipment 11b and 11d.

The warning target display field G3a indicates that the type of warning is “warning 1”, that is, the warning is based on the first numerical information v1 (60). The warning target display field G3b indicates that the type of warning is “warning 2”, that is, the warning is based on the second numerical information v2 (60).

The transition screen creating unit 54c is a functional unit that creates a screen representing chronological transition of the value of the second numerical information v2 (hereinafter this screen is referred to as a “transition screen”) for each of the pieces of lighting equipment 11a to 11e on the basis of the second numerical information v2.

Specifically, as illustrated in FIG. 15, the transition screen creating unit 54c creates, on the basis of the second numerical information v2 for past several days obtained from the numerical calculation unit 53, a transition screen G4 in which the difference df2 between the changed schedule information CS1 and the equipment operation time information D1 about the lighting equipment 11d is chronologically represented by a line chart.

The transition screen G4 indicates that the value of the second numerical information v2 gradually increases and that the value exceeds the threshold th1 (in this case “30”), which is the case where “warning 2” is given, on Jan. 9, 2015.

### Operation of Central Control Apparatus

Next, a description will be given of an operation of creating and displaying difference visualized screens (the histogram screen G2, the warning screen G3, and the transition screen G4) that enable the first difference df1 between the schedule information S1 and the changed schedule information CS1 and the second difference df2 between the changed schedule information CS1 and the equipment operation time information D1 to be visualized, performed by the central control apparatus 50S.

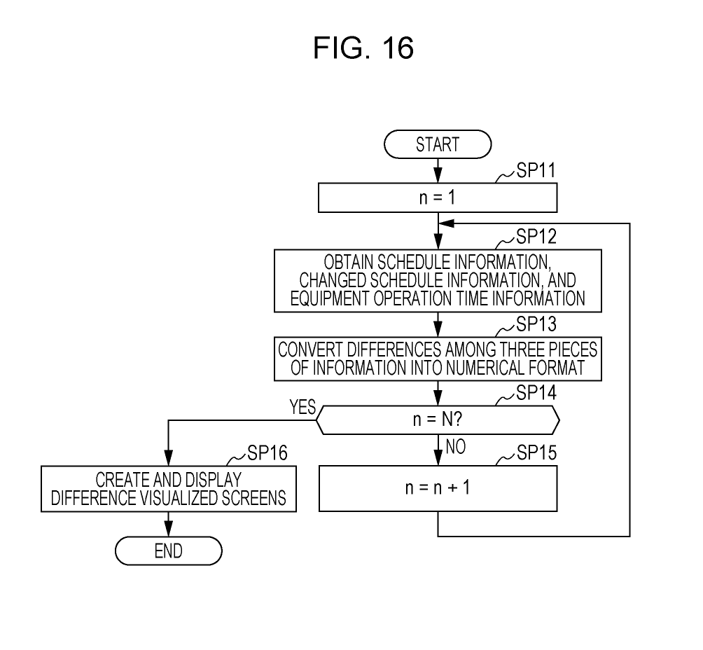

Referring to FIG. 16, the central control apparatus 50S needs to obtain, by using the numerical calculation unit 53, N pieces of schedule information S1, N pieces of changed schedule information CS1, and N pieces of equipment operation time information D1 from the pieces of lighting equipment 11a to 11e (in this case, N=5), and sets an initial value “n=1” to count the number (N) of the pieces of lighting equipment 11a to 11e (step SP11).

The central control apparatus 50S obtains, by using the numerical calculation unit 53, the schedule information S1, the changed schedule information CS1, and the equipment operation time information D1 about the lighting equipment 11a (step SP12).

The central control apparatus 50S converts the first difference df1 and the second difference df2 into a numerical format on the basis of the schedule information S1, the changed schedule information CS1, and the equipment operation time information D1, and thereby calculates the first numerical information v1 and the second numerical information v2 for the lighting equipment 11a (step SP13).

The central control apparatus 50S determines, by using the numerical calculation unit 53, whether or not n=N is satisfied (step SP14). If n=N is not satisfied (NO in step SP14), the process proceeds to step SP15, where 1 is added to n (n=n+1). After that the process returns to step SP12.

The central control apparatus 50S sequentially obtains the schedule information S1, the changed schedule information CS1, and the equipment operation time information D1 about the pieces of lighting equipment 11b to 11e in the same manner (step SP12) and calculates the first numerical information v1 and the second numerical information v2 for the pieces of lighting equipment 11b to 11e (step SP13).

If the central control apparatus 50S determines, by using the numerical calculation unit 53, that n=N is satisfied (YES in step SP14), the central control apparatus 50S creates, by using the difference-visualized-screen creating unit 54, difference visualized screens (the histogram screen G2, the warning screen G3, and the transition screen G4) on the basis of the first numerical information v1 and the second numerical information v2, and displays the screens on the monitor 60 in response to a request from the operator (SP16). After that the process ends.

### Advantages of Second Embodiment

The central control apparatus 50S is able to display, by using the display control unit 56, the comparison screens G1 (see FIG. 7) or the comparison screens G1s (see FIG. 8) for the individual pieces of lighting equipment 11a to 11e created by the comparison screen creating unit 52 of the screen creating unit 55 on the monitor 60 in accordance with an operation performed on the input unit by an operator, as in the first embodiment.

On the comparison screens G1 for the individual pieces of lighting equipment 11a to 11e, all the causes of the delay in operation of the pieces of lighting equipment 11a to 11e can be specified only if the operator checks all the comparison screens G1 for the individual pieces of lighting equipment 11a to 11e.

However, the display control unit 56 of the central control apparatus 50S is able to display, on the monitor 60, the histogram screen G2 for the pieces of lighting equipment 11a to 11e created by the graph screen creating unit 54a instead of the comparison screens G1, in response to receipt of a request for displaying the histogram screen G2 in accordance with an operation performed on the input unit by the operator.

By checking the histogram screen G2 (see FIG. 13), the operator is able to instantaneously understand that only the pieces of lighting equipment 11b and 11d among the plurality of pieces of lighting equipment 11a to 11e have a time difference among the schedule information S1, the changed schedule information CS1, and the equipment operation time information D1.

Specifically, the operator recognizes the blue bin for the lighting equipment 11b on the histogram screen G2 and is thereby able to understand that the cause of the operation of the lighting equipment 11b behind schedule represented by the schedule information S1 is the change of the end time in the schedule information S1 according to the changed schedule information CS1.

Also, the operator recognizes the red bin for the lighting equipment 11d and is thereby able to understand that the cause of the operation of the lighting equipment 11d behind schedule represented by the changed schedule information CS1 is failure of communication between the control apparatus 20A and the lighting equipment 11d.

In this way, the operator is able to recognize all the causes of the delay in operation of the pieces of lighting equipment 11a to 11e only by checking the histogram screen G2.

In response to receipt of a request for displaying the warning screen G3 for the pieces of lighting equipment 11a to 11e in accordance with an operation performed on the input unit by the operator, the display control unit 56 is able to display the warning screen G3 created by the warning screen creating unit 54b instead of the histogram screen G2 on the monitor 60.

Accordingly, the operator recognizes, through the warning target display field G3a of the warning screen G3, that the lighting equipment 11b is the target of warning and is thereby able to contact an operation manager of the room R1 in which the lighting equipment 11b is installed and determine whether turning off of the lighting equipment 11b is forgotten.

Also, the operator recognizes, through the warning target display field G3b of the warning screen G3, that the lighting equipment 11d is the target of warning and is thereby able to inspect the communication function of the lighting equipment 11d.

In response to receipt of a request for displaying the transition screen G4 for the lighting equipment 11d for which communication failure has been recognized in accordance with an operation performed on the input unit by the operator, the display control unit 56 of the central control apparatus 50S is able to display the transition screen G4 for the lighting equipment 11d created by the transition screen creating unit 54c on the monitor 60, instead of the warning screen G3.

Accordingly, the operator is able to understand that communication failure has been increasing for the past several days by checking the transition screen G4. Thus, the operator is able to determine, on the basis of the transition screen G4, that the communication function of the lighting equipment 11d has been degrading, and is thus able to use the transition screen G4 for degradation diagnosis of the individual pieces of lighting equipment 11a to 11e.

### Third Embodiment

A schedule management system according to the third embodiment is a system that calculates the first numerical information v1 and the second numerical information v2 for each of an operating time section (8:00 to 18:00) in which the pieces of lighting equipment 11a to 11e are on and a non-operating time section (0:00 to 8:00 and 18:00 to 23:59) in which the pieces of lighting equipment 11a to 11e are off, instead of for all day from 0:00 to 23:59:59, and that causes an operator to specify the cause of a delay in operation of the pieces of lighting equipment in the operating time section or non-operating time section on the basis of the first numerical information v1 and the second numerical information v2.

The basic configuration of the schedule management system according to the third embodiment is the same as that of the schedule management system 100 according to the second embodiment, but the numerical calculation method used by the numerical calculation unit 53 is different.

The numerical calculation unit 53 according to the third embodiment calculates the first numerical information v1 and the second numerical information v2 for each of the operating time section (8:00 to 18:00) in which the pieces of lighting equipment 11a to 11e are on and the non-operating time section (0:00 to 8:00 and 18:00 to 23:59) in which the pieces of lighting equipment 11a to 11e are off, on the basis of the schedule information S1.

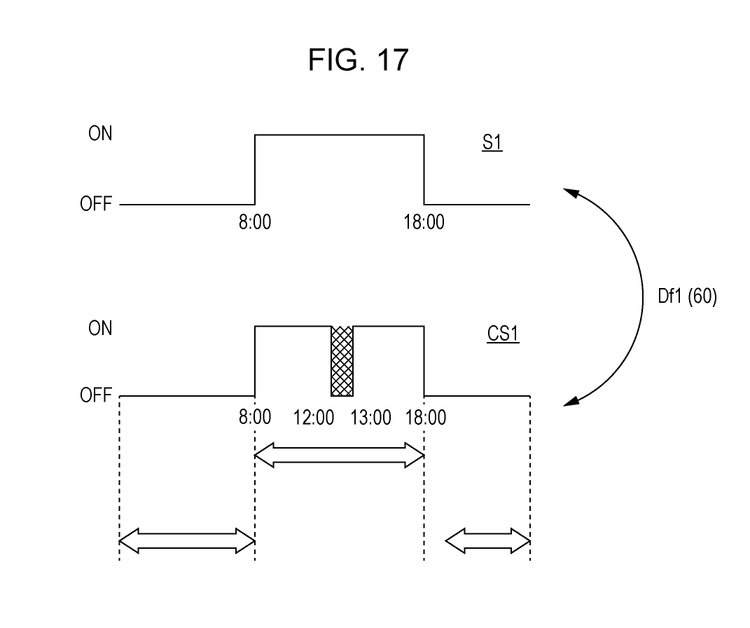

For example, as illustrated in FIG. 17, if the control apparatus 20A generates the changed schedule information CS1 so as to cause the lighting equipment 11a to be in an off state during a lunch break (12:00 to 13:00) in the operating time section (8:00 to 18:00) of the pieces of lighting equipment 11a to 11e in accordance with a change request from the on-site operation device 14A, the first numerical information v1 in the operating time section is “60”.

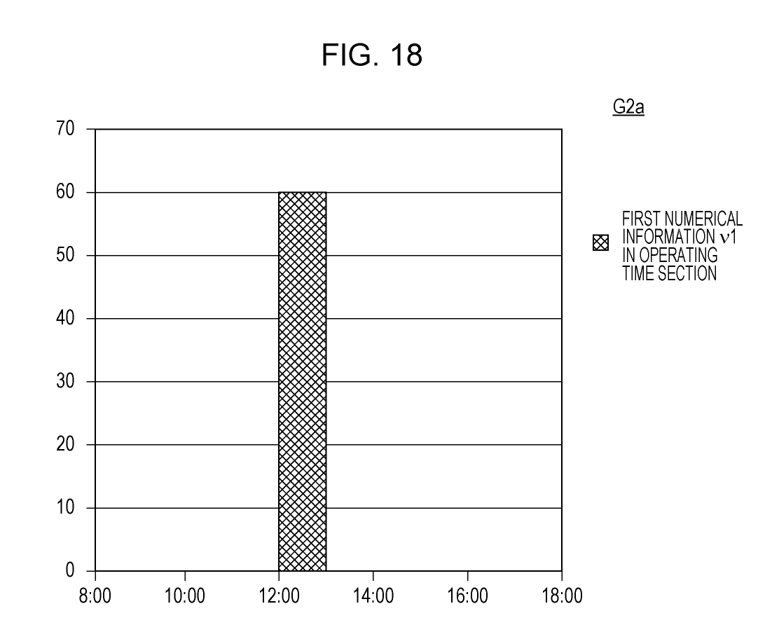

The graph screen creating unit 54a creates a histogram screen G2a illustrated in FIG. 18 in which the bin for the time section from 12:00 to 13:00 is colored in blue, on the basis of the first numerical information v1 about the lighting equipment 11a in the operating time section, and the display control unit 56 displays the histogram screen G2a on the monitor 60. The histogram screen G2a is a screen for only the lighting equipment 11a, and the horizontal axis thereof indicates the operating time section 8:00 to 18:00.

The operator checks the time section corresponding to the bin (12:00 to 13:00) on the histogram screen G2a and is thereby able to understand that the cause of the operation of the lighting equipment 11a behind schedule represented by the schedule information S1 is the changed schedule information CS1 generated by changing the schedule information S1 from the viewpoint of energy saving in the lunch break.

### Fourth Embodiment

A schedule management system according to the fourth embodiment is a system that enables an operator to specify the cause of a delay in the operation of lighting equipment by generating a plurality of pieces of changed schedule information CS1 and CS2 in response to a plurality of requests for changing the schedule information S1 and visualizing and displaying a time difference between the schedule information S1 and the changed schedule information CS1, a time difference between the changed schedule information CS1 and the changed schedule information CS2, and a time difference between the changed schedule information CS2 and the equipment operation time information D1.

The basic configuration of the schedule management system according to the fourth embodiment is the same as that of the schedule management systems 100 according to the first and second embodiments. The difference is that the changed schedule information generating unit 20c of the control apparatus 20A generates a plurality of pieces of changed schedule information CS1 and CS2.

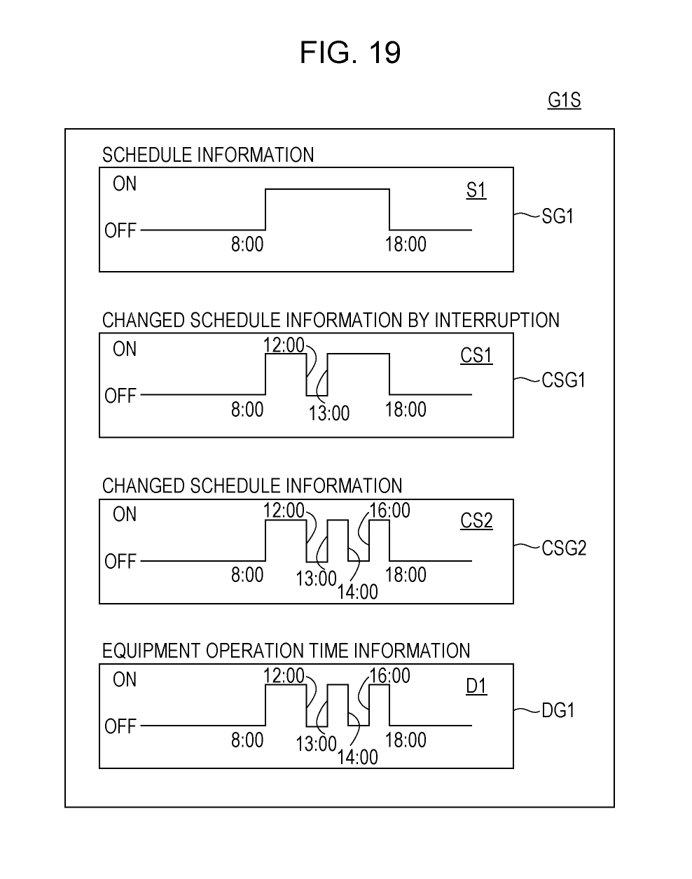

As illustrated in FIG. 19, the changed schedule information generating unit 20c generates, regarding the schedule information S1 representing a start time 8:00 and an end time 18:00, changed schedule information CS1 indicating that the schedule is changed to make the pieces of lighting equipment 11a to 11e off from 12:00 to 13:00, and stores the changed schedule information CS1 as a first intermediate state in the schedule information storage unit 20b.

Also, the changed schedule information generating unit 20c generates, regarding the changed schedule information CS1, changed schedule information CS2 indicating that the schedule is further changed to make the pieces of lighting equipment 11a to 11e off from 14:00 to 15:00, and stores the changed schedule information CS2 as a second intermediate state in the schedule information storage unit 20b.

The comparison screen creating unit 52 creates a schedule information screen SG1 that enables a rise from OFF to ON at a start time 8:00 and a fall from ON to OFF at an end time 18:00 to be visualized, on the basis of the schedule information S1.

Also, the comparison screen creating unit 52 creates a changed schedule information screen CSG1 that enables a rise from OFF to ON at a start time 8:00, a fall from ON to OFF at a time 12:00, a rise from OFF to ON at a time 13:00, and a fall from ON to OFF at an end time 18:00 to be visualized, on the basis of the changed schedule information CS1.

Likewise, the comparison screen creating unit 52 creates a changed schedule information screen CSG2 that enables a rise from OFF to ON at a start time 8:00, a fall from ON to OFF at a time 12:00, a rise from OFF to ON at a time 13:00, a fall from ON to OFF at a time 14:00, a rise from OFF to ON at a time 15:00, and a fall from ON to OFF at an end time 18:00 to be visualized, on the basis of the changed schedule information CS2.

Furthermore, the comparison screen creating unit 52 creates an equipment operation time information screen DG1 similar to the changed schedule information screen CSG2 on the basis of the equipment operation time information D1.

Subsequently, the comparison screen creating unit 52 creates a comparison screen G1S on which the schedule information screen SG1, the changed schedule information screens CSG1 and CSG2, and the equipment operation time information screen DG1 are vertically arranged in a line along the same time axis. The display control unit 56 displays the comparison screen G1S on the monitor 60.

The comparison screen G1S is displayed such that the time difference between the schedule information S1 and the changed schedule information CS1 and the time difference between the changed schedule information CS1 and the changed schedule information CS2 are visualized on the changed schedule information screens CSG1 and CSG2.

The operator checks the changed schedule information screens CSG1 and CSG2 on the comparison screen G1S, and is thereby able to intuitively recognize that there are two time differences between the schedule information S1 and the equipment operation time information D1 and that the cause thereof is the generation of the changed schedule information CS1 and CS2.

The numerical calculation unit 53 calculates first numerical information v1 that is obtained by converting the first difference df1 between the schedule information S1 and the changed schedule information CS1 into a numerical format, first numerical information v1′ that is obtained by converting the first difference df1′ between the changed schedule information CS1 and the changed schedule information CS2 into a numerical format, and second numerical information v2 that is obtained by converting the second difference df2 between the changed schedule information CS2 and the equipment operation time information D1 into a numerical format. In this case, the first numerical information v1 is “60”, the first numerical information v1′ is “60”, and the second numerical information v2 is “0”.

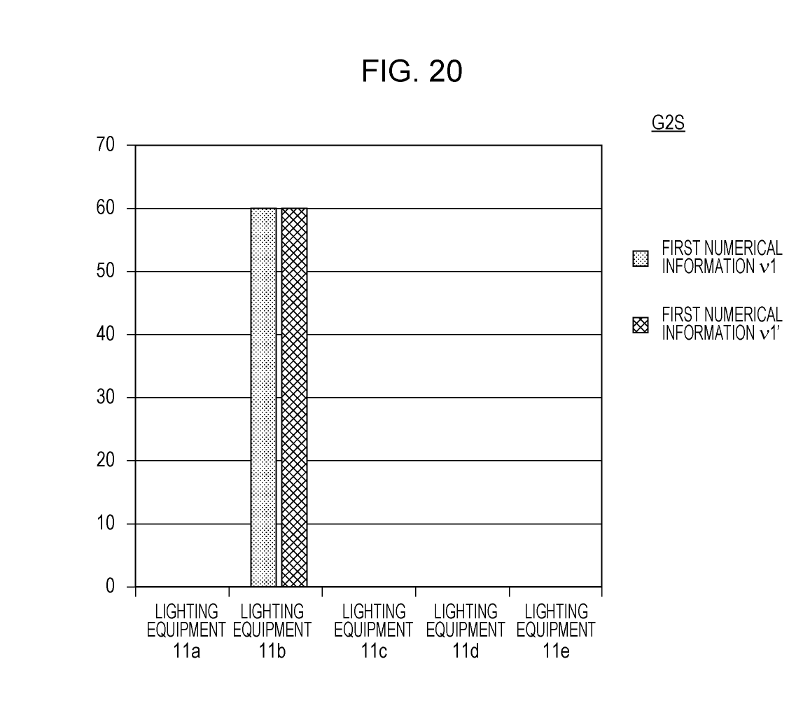

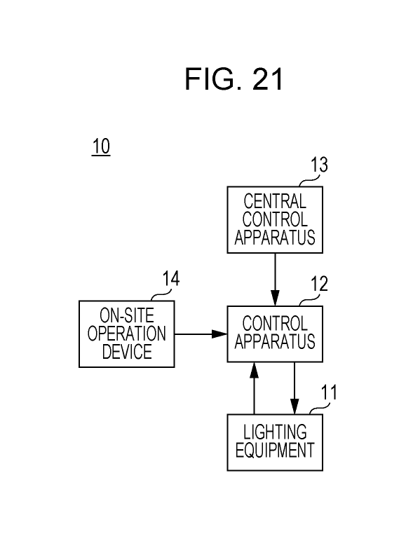

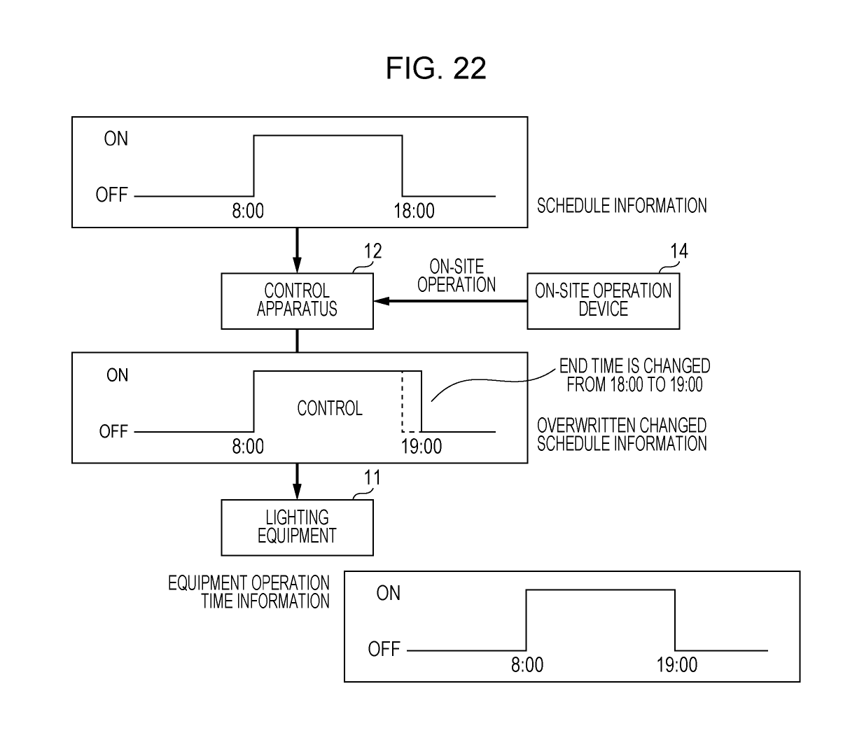

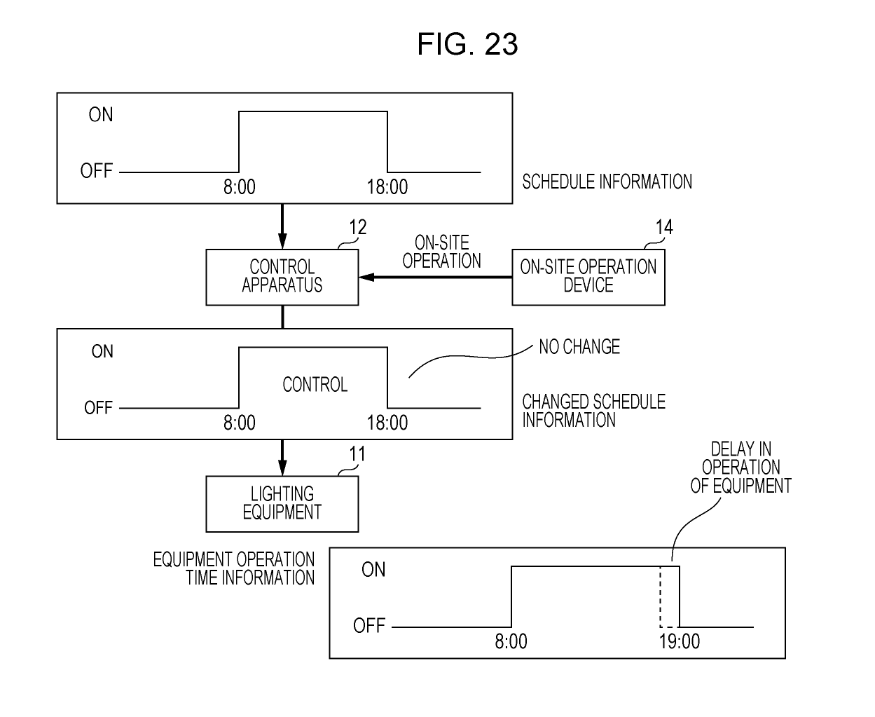

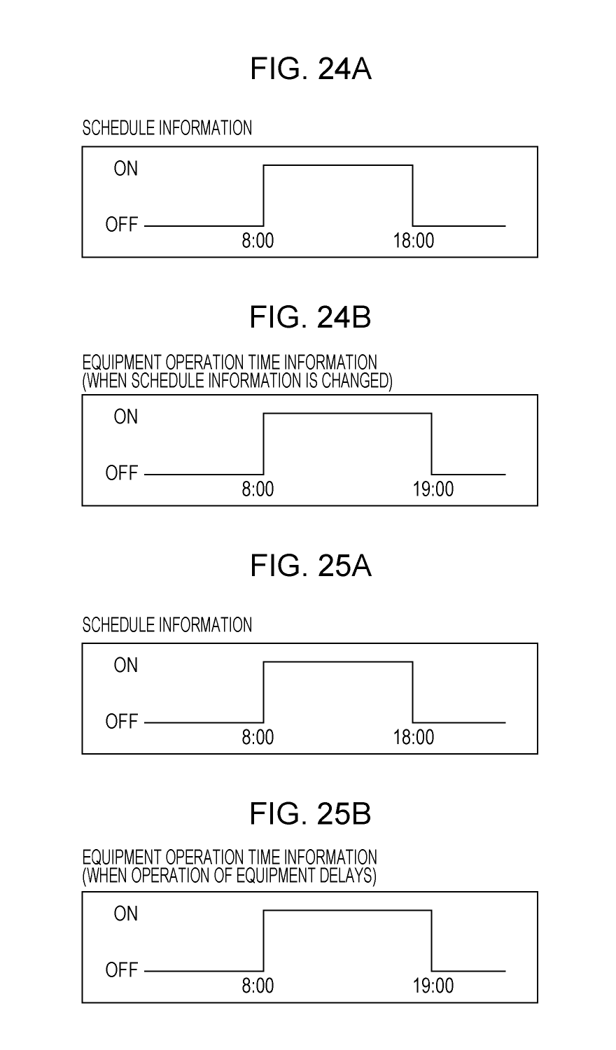

The graph screen creating unit 54a of the difference-visualized-screen creating unit 54 creates, as a difference visualized screen, the histogram screen G2S illustrated in FIG. 20 in which the first intermediate state and the second intermediate state are reflected, on the basis of the first numerical information v1 and the first numerical information v1′. The display control unit 56 is able to display the histogram screen G2S on the monitor 60.

The difference-visualized-screen creating unit 54 is able to create a warning screen and a transition screen by using the warning screen creating unit 54b and the transition screen creating unit 54c on the basis of the first numerical information v1 and the first numerical information v1′.

### OTHER EMBODIMENTS

In the above-described first to third embodiments, a description has been given of a case where the changed schedule information generating unit 20c and the equipment operation time information generating unit 20e are included in the control apparatus 20A. The present disclosure is not limited thereto. The changed schedule information generating unit 20c and the equipment operation time information generating unit 20e may be included in the central control apparatus 50.

In the above-described second embodiment, a description has been given of a case where the first numerical information v1 and the second numerical information v2 are calculated by adding all the absolute values of differences x(t). The present disclosure is not limited thereto. Since the schedule information S1, the changed schedule information CS1, and the equipment operation time information D1 are pieces of time-series data, a difference therebetween may be converted into a numerical format by using a method called dynamic time warping (DTW) or other various methods.

In the above-described second embodiment, a description has been given of a case where the total sum of differences x(t) calculated at an interval of one minute is calculated as the first numerical information v1 and the second numerical information v2 by using Equation 1 under the assumption that ON corresponds to “1” and OFF corresponds to “0”. The present disclosure is not limited thereto. If air-conditioning equipment is used as a target instead of lighting equipment, the first numerical information v1 and the second numerical information v2 may be calculated as a difference x(t) between analog values of a set room temperature and an actual room temperature.

In this case, the central control apparatus 50S creates, by using the transition screen creating unit 54c, a transition screen on the basis of the second numerical information v2 and displays the transition screen. Accordingly, the operator is able to recognize that a difference between the set temperature and the room temperature is becoming larger and understand that the control ability of the air-conditioning equipment is degrading.

Furthermore, in the above-described second embodiment, a description has been given of a case where the histogram screen G2 is created on the basis of the first numerical information v1 and the second numerical information v2 and is displayed. The present disclosure is not limited thereto. Two types of histogram screens may be created on the basis of the first numerical information v1 or the second numerical information v2.

The central control apparatus 50S may create and display only a histogram screen on the basis of the first numerical information v1 for an energy manager who wants to determine whether or not the pieces of lighting equipment 11a to 11e are operating in accordance with the schedule information S1. Alternatively, the central control apparatus 50S may create and display only a histogram screen on the basis of the second numerical information v2 for maintenance staff who wants to determine whether or not the pieces of lighting equipment 11a to 11e are normally functioning.

Furthermore, in the above-described second embodiment, a description has been given of a case where the histogram screen G2, the warning screen G3, and the transition screen G4 are displayed instead of the comparison screen G1. The present disclosure is not limited thereto. The display manner may be arbitrarily set, for example, the histogram screen G2, the warning screen G3, and the transition screen G4 are displayed together with the comparison screen G1.

1. A schedule management system, comprising:
processing circuitry configured to
generate schedule information for managing operation of equipment;
generate changed schedule information by changing the schedule information in response to a request for changing the schedule information;
generate equipment operation time information representing an operation time of the equipment when the equipment operates in accordance with the schedule information or the changed schedule information;
create a presentation screen including information on a first difference between the schedule information and the changed schedule information and a second difference between the changed schedule information and the equipment operation time information; and
control a display to display the presentation screen.

2. The schedule management system according to claim 1, wherein the processing circuitry is further configured to:
generate a predetermined schedule information screen, a predetermined changed schedule information screen, and a predetermined equipment operation time information screen on the basis of the schedule information, the changed schedule information, and the equipment operation time information; and
create, as the presentation screen, a comparison screen on which the schedule information screen, the changed schedule information screen, and the equipment operation time information screen are arranged.

3. The schedule management system according to claim 1, wherein the processing circuitry is further configured to calculate first numerical information and second numerical information, the first numerical information being obtained by converting the first difference into a numerical format, and the second numerical information being obtained by converting the second difference into a numerical format.

4. The schedule management system according to claim 3, wherein the processing circuitry is further configured to create a graph screen as the presentation screen on the basis of the first numerical information and the second numerical information.

5. The schedule management system according to claim 3, wherein the processing circuitry is further configured to create a warning screen as the presentation screen on the basis of the first numerical information and the second numerical information, the warning screen representing a warning indicating that at least one of the first difference and the second difference is detected.

6. The schedule management system according to claim 3, wherein the processing circuitry is further configured to create a transition screen as the presentation screen on the basis of the second numerical information, the transition screen representing a chronological transition of the second difference.

7. The schedule management system according to claim 4, wherein the processing circuitry is further configured to:
calculate the first numerical information in an operating time section in which the equipment is operating and the first numerical information in a non-operating time section in which the equipment is not operating, and
create the graph screen on the basis of the first numerical information in the operating time section and the first numerical information in the non-operating time section.

8. The schedule management system according to claim 2, wherein the processing circuitry is further configured to:
generate a plurality of pieces of changed schedule information in response to a plurality of requests for changing the schedule information,
create a plurality of changed schedule information screens on the basis of the plurality of pieces of changed schedule information, and
create a comparison screen on which the schedule information screen, the plurality of changed schedule information screens, and the equipment operation time information screen are arranged.

9. The schedule management system according to claim 1, wherein the processing circuitry is further configured to control the display to display the schedule information, the changed schedule information, and the equipment operation time information using time axis information and on and off states information of the equipment.

10. The schedule management system according to claim 9, wherein the processing circuitry is further configured to control the display to display the on and off states information of the equipment in a first axis, and display the time axis information on a second axis perpendicular to the first axis.

11. The schedule management system according to claim 10, wherein the processing circuitry is further configured to control the display to display a first region corresponding to the first difference with emphasis, and display a second region corresponding to the second difference with emphasis.

12. The schedule management system according to claim 3, wherein the processing circuitry is further configured to control the display to display the first numerical information and the second numerical information for each of the equipment and additional equipment.

13. A schedule management method comprising:
generating, using processing circuitry, schedule information for managing operation of equipment;
generating, using the processing circuitry, changed schedule information by changing the schedule information in response to a request for changing the schedule information;
generating, using the processing circuitry, equipment operation time information representing an operation time of the equipment when the equipment operates in accordance with the schedule information or the changed schedule information;
creating, using the processing circuitry, a presentation screen including information on a first difference between the schedule information and the changed schedule information and a second difference between the changed schedule information and the equipment operation time information; and
controlling a display to display the presentation screen.

14. The schedule management method according to claim 13, further comprising:
generating, using the processing circuitry, a predetermined schedule information screen, a predetermined changed schedule information screen, and a predetermined equipment operation time information screen on the basis of the schedule information, the changed schedule information, and the equipment operation time information; and
creating, using the processing circuitry, as the presentation screen, a comparison screen on which the schedule information screen, the changed schedule information screen, and the equipment operation time information screen are arranged.

15. The schedule management method according to claim 13, further comprising:
calculating, using the processing circuitry, first numerical information and second numerical information, the first numerical information being obtained by converting the first difference into a numerical format, the second numerical information being obtained by converting the second difference into a numerical format.

16. A non-transitory computer readable medium including executable instructions, which when executed by a computer cause the computer to:
generate schedule information for managing operation of equipment;
generate changed schedule information by changing the schedule information in response to a request for changing the schedule information;
generate equipment operation time information representing an operation time of the equipment when the equipment operates in accordance with the schedule information or the changed schedule information;
create a presentation screen including information on a first difference between the schedule information and the changed schedule information and a second difference between the changed schedule information and the equipment operation time information; and
control a display to display the presentation screen.

17. The non-transitory computer readable medium according to claim 16, wherein the executable instructions when executed by the computer further cause the computer to:
generate a predetermined schedule information screen, a predetermined changed schedule information screen, and a predetermined equipment operation time information screen on the basis of the schedule information, the changed schedule information, and the equipment operation time information; and
create, as the presentation screen, a comparison screen on which the schedule information screen, the changed schedule information screen, and the equipment operation time information screen are arranged.

18. The non-transitory computer readable medium according to claim 16, wherein the executable instructions when executed by the computer further cause the computer to:
calculate first numerical information and second numerical information, the first numerical information being obtained by converting the first difference into a numerical format, the second numerical information being obtained by converting the second difference into a numerical format.
